(19) United States
(12) Patent Application Publication
(10) Pub. No.: US 2008/0276664 A1
(43) Pub. Date: Nov. 13, 2008

(54) Steel cable fastenable to a lock

(75) Inventor: Chang Chin Shu, Changhua City (TW)

Correspondence Address: BRUCE H. TROXELL;SUITE 1404, 5205 LEESBURG PIKE, FALLS CHURCH, VA, 22041, US

(73) Assignee: VULCAN SPORTS CO., LTD.

(21) Appl. No.: 11/798,316

(22) Filed: May 11, 2007

(51) Int. Cl. E05B 73/00

(52) U.S. Cl. 70/18

(57) ABSTRACT

A steel cable fastenable to a lock also providing light reflective alert function includes at least a steel cable body, a covering layer and a reflective zone. The reflective zone is a bonding layer with the surface capable of reflecting light projecting thereon. The bonding layer is bonded to the outer surface of the covering layer. The steel cable thus formed can be fastened to the lock to prevent theft and also provide safety alert function.

### BACKGROUND OF THE INVENTION

1. Field of the Invention

The present invention relates to a steel cable fastenable to a lock and particularly to a steel cable that has a light reflective alert means to provide safety alert function and also is fastenable to a lock to thwart pilferage.

2. Description of the Prior Art

Conventional steel cables fastenable to a lock are commonly used on bicycles to prevent theft but do not have other function. Many other bicycle accessories generally provide same safety alert function to enhance safety of bicycle riding, such as reflective stickers, alarm flashlights and the like. The steel cables are usually formed in a dark color (mainly black or gray) and occupy some space at certain locations, but contribute little to the safety of bicycle riding. There are still rooms for improvement.

### SUMMARY OF THE INVENTION

In view of the aforesaid drawbacks occurred to the conventional steel cables, the present invention aims to provide a steel cable fastenable to a lock that also provides light reflective alert function. It includes at least a steel cable body, a covering layer and a reflective zone. The reflective zone is a bonding layer with a surface to reflect light. The bonding layer is located on an outer surface of the covering layer. Through the reflective zone the steel cable thus formed can provide theft-thwarting and safety alert functions.

In one aspect the steel cable body is a rope consisting of a plurality of steel wires twisted together. The steel cable has a first end and a second end that are respectively formed in an annular loop to be shackled by a lock.

In another aspect the first end of the steel cable is fastened to a lock and the second end is fastened to a bolt.

In yet another aspect the steel cable may be wound to become a helical body with the reflective zone located on an outer side of the surface of the helical body.

In yet another aspect the reflective zone is a bonding layer formed in an elongate strip.

In yet another aspect the covering layer is made from plastics to cover the outer surface of the steel cable body.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fragmentary exploded view of the invention.

FIG. 2 is a cross section of the invention.

FIG. 3 is a perspective view of an embodiment of the invention.

FIG. 4 is a schematic view of an embodiment of the invention used on a bicycle.

FIG. 5 is a perspective view of another embodiment of the invention.

FIG. 6 is a schematic view of another embodiment of the invention used on a bicycle.

### DESCRIPTION OF THE PREFERRED EMBODIMENTS

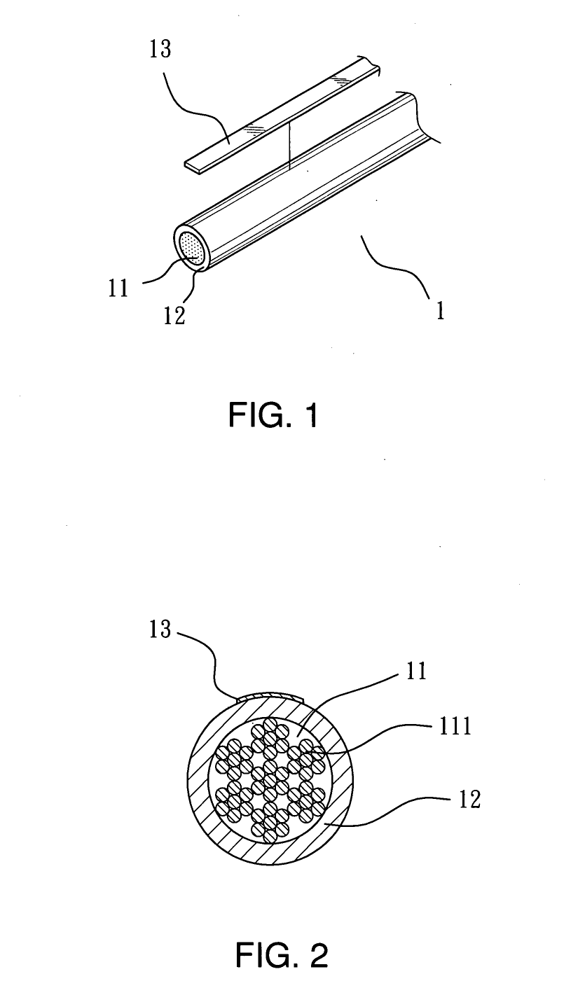

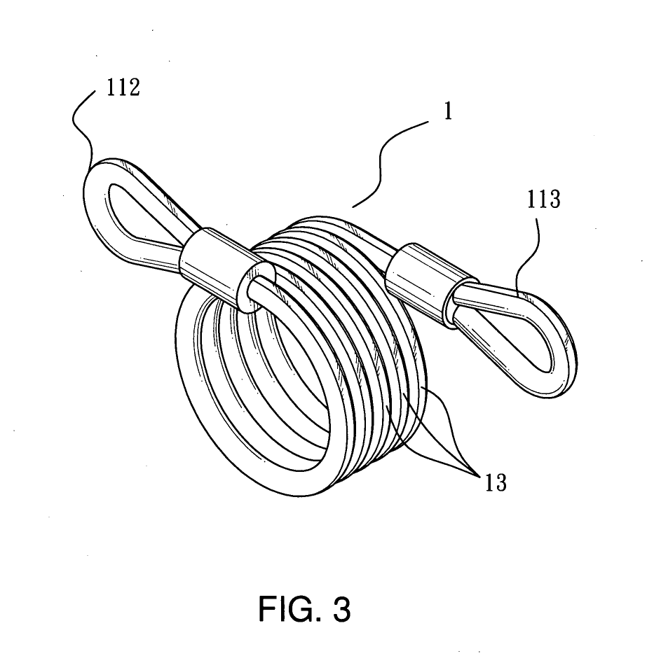

Referring to FIGS. 1, 2 and 3, the steel cable 1 fastenable to a lock according to the invention includes a steel cable body 11, a covering layer 12 and a reflective zone 13.

The steel cable body 11 is a rope consisting of a plurality of steel wires 111 twisted together.

The covering layer 12 is made from plastics and covers the outer surface of the steel cable body 11.

The reflective zone 13 is a bonding layer with a surface capable of reflecting light projected thereon. The bonding layer is an elongate strip bonding to an outer surface of the covering layer 12.

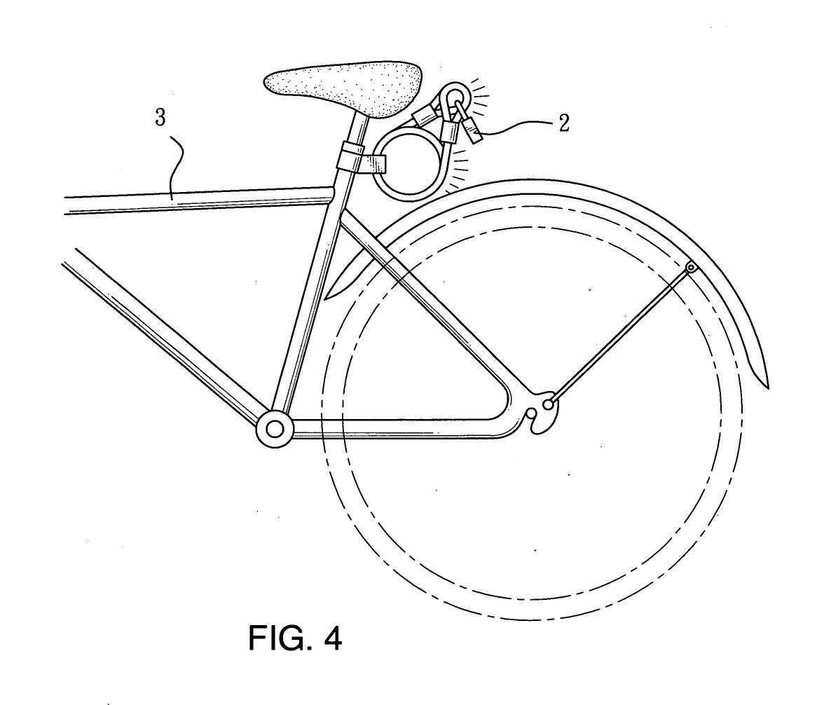

Refer to FIGS. 3 and 4 for an embodiment of the invention. The steel cable 1 may be wound to become a helical body to facilitate carrying. The steel cable 1 has a first end 112 and a second end 113 that are respectively an annular loop to be shackled by a lock 2. The reflective zone 13 is located on an outer side of the surface of the helical body. When the steel cable 1 is hung on a bicycle 3 the steel cable 1 can reflect light to provide alert function to enhance riding safety of the bicycle.

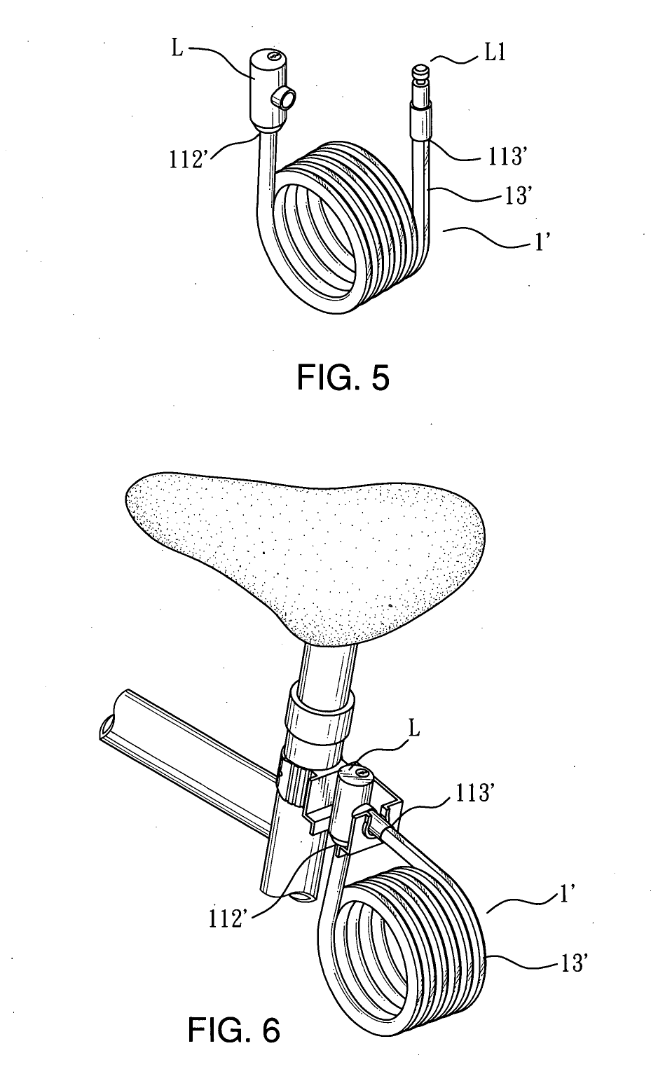

Refer to FIGS. 5 and 6 for another embodiment of the invention. The steel cable 1′ has a reflective zone 13′ bonding to an outer surface thereof. The steel cable 1′ has a first end 112′ fastened to a lock L to be coupled by a bolt L1 fastened to a second end 113′. Thus users do not have to carry an extra lock when in use. It is more convenient.

In short, the invention can resolve the shortcomings of the conventional steel cables and enhance the riding safety of bicycles.

I claim:

1. A steel cable fastenable to a lock, comprising:
a steel cable body which is a rope consisting of a plurality of steel wires twisted together;
a covering layer made from plastics to cover the steel cable body; and
a reflective zone which is a bonding layer adhering to an outer surface of the covering layer to reflect light projecting thereon.

2. The steel cable fastenable to a lock of claim 1, wherein the steel cable is wound to form a helical body, the reflective zone being located on an outer side of the surface of the helical body.

3. The steel cable fastenable to a lock of claim 1, wherein the reflective zone is a bonding layer formed in an elongate strip.

4. The steel cable fastenable to a lock of claim 1, wherein the steel cable has a first end formed in an annular loop.

5. The steel cable fastenable to a lock of claim 1, wherein the steel cable has a second end formed in an annular loop.

6. The steel cable fastenable to a lock of claim 1, wherein the steel cable has a first end fastened to a lock and a second end fastened to a bolt which is fastenable to the lock.
